(19) United States
(12) Patent Application Publication
(10) Pub. No.: US 2026/0032502 A1
(43) Pub. Date: Jan. 29, 2026

(54) CSI and Multi-TRP

(71) Applicant: Fraunhofer-Gesellschaft zur Förderung der angewandten Forschung e.V., München (DE)

(72) Inventors: Paul Simon Holt LEATHER, Berlin-Schlachtensee (DE); Thomas HAUSTEIN, Berlin (DE); Lars THIELE, Berlin (DE)

(21) Appl. No.: 19/350,225

(22) Filed: Oct. 6, 2025

Related U.S. Application Data
(63) Continuation of application No. PCT/EP2024/059377, filed on Apr. 5, 2024.

(30) Foreign Application Priority Data
Apr. 6, 2023 (EP) 23166997.9
Aug. 10, 2023 (EP) 23190911.0

(51) Int. Cl. H04W 24/10

(52) U.S. Cl. CPC H04W 24/10

(57) ABSTRACT

A device such as a base station or a user equipment, UE, is configured for operating in a wireless communication network. The device is configured for evaluating a set of resource elements, RE, of the wireless communication network for a reception of a signal transmitted from a transmission/reception device, TRD, not serving the device to obtain a measurement result and is configured for providing a report based on the measurement result; or configured for using the measurement result for future operation of the device in the wireless communication network.

### CROSS-REFERENCE TO RELATED APPLICATIONS

This application is a continuation of copending International Application No. PCT/EP2024/059377, filed Apr. 5, 2024, which is incorporated herein by reference in its entirety, and additionally claims priority from European Application No. 23166997.9, filed Apr. 6, 2023, and from European Application No. 23190911.0, filed Aug. 10, 2023, which are also incorporated herein by reference in their entirety.

### TECHNICAL FIELD

Embodiments of the present application relate to the field of wireless communication, and more specifically, to providing signals to a device by use of one or more transmission reception points, TRPs. Some embodiments relate to evaluating signals provided by a non-serving TRP.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 1061 to 1065. The base stations are provided to serve users within a cell. The term base station (also basestation), BS, refers to a gNB in 5G networks, an eNB in UMTS/LTE/LTE-A/LTE-A Pro, or just a BS in other mobile communication standards. A user may be a stationary device or a mobile device.

The network 100 may comprise one or more transmission reception points, TRPs. A TRP may but is not required to form an individual node of the network. For example, a base station may comprise one or a plurality of TRPs. For example, different TRPs of a base station may serve UEs in different areas or sectors of a cell operated by the base station, just to name a specific example.

The wireless communication system may also be accessed by mobile or stationary IoT devices which connect to a base station or to a user. The mobile devices or the IoT devices may include physical devices, ground-based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an example of five cells, however, the RANₙ may include more or fewer such cells, and RANₙ may also include only one base station. FIG. 1(b) shows two users UE₁ and UE₂, also referred to as user equipment, UE, that are in cell 1062 and that are served by base station gNB2.

Another user UEs is shown in cell 106₄ which is served by base station gNB4. The arrows 1081, 1082 and 1083 schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. Furthermore, some or all of the respective base stations gNB₁ to gNB₅ may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI), respectively. For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTIs) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the terrestrial wireless networks describe above, non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage”does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station cannot provide sidelink resource allocation configuration or assistance for the UEs, and/or
may be connected to the base station that cannot support NR V2X services, e.g., GSM, UMTS, LTE base stations.

When considering two UEs directly communicating with each other over the sidelink, e.g., using the PC5 interface, one of the UEs may also be connected with a BS, and can thus relay information from the BS to the other UE via the sidelink interface. Such relaying can be performed in the same frequency band (in-band-relay) or another frequency band (out-of-band relay) can be used. In the first case, communication on the Uu and on the sidelink may be decoupled using different time slots as in time division duplex, TDD, systems.

FIG. 2a is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2b is a schematic representation of an out-of-coverage scenario in which the UEs directly communicating with each other are either not connected to a base station, although they can be physically within a cell of a wireless communication network, or some or all of the UEs directly communicating with each other are communicating with/connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2b which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2a, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 3 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 4 is a schematic representation of a scenario in which two UEs directly communicating with each other, wherein the two UEs are connected to different base stations. The first base station gNB1 has a coverage area that is schematically represented by the first circle 200₁, wherein the second station gNB2 has a coverage area that is schematically represented by the second circle 200₂. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 200₂ of the second base station gNB2 and connected to the second base station gNB2 via the Uu interface.

A scenario described herein may not only comprise nodes like base stations, UEs, IoT devices, but also transmission reception points, TRPs.

In a wireless communication system by way of non-limiting example such as described above, when a device (e.g. a user equipment, UE) is connected to its serving cell or basestation, BS, it provides reports, to the serving BS in the form of channel state information, CSI, of the radio channel based on reference signals, RS, that were transmitted from the BS and received by the UE. Within a known implementation of a CSI-RS framework, the serving BS can configure the UE to measure CSI-RS, i.e., pilots to measure channels from serving BS, and interference on CSI interference (channel) measurement, CSI-IM, resources. Such resource elements, RE, can be coordinated between different BSs such that mutual interference is minimized. Means to do this include the muting of the CSI-RS and/or the PDSCH data on the serving BS and/or on other BSs—further details of which are described in [1].

The current CSI-RS framework enables the UE to perform reliable measurements of CSI and interference by providing suitable RE and coordinated resource allocation across adjacent BSs. The UE is thus enabled to perform local measurements that provide for better channel estimation, channel control, data channel decoding and better link adaptation.

However, such an approach is considered to provide insufficient basis for channel optimisation.

There is, thus, a need to improve wireless communications.

It is noted that the information in the above section is only for enhancing the understanding of the background of the invention and therefore it may contain information that does not form conventional technology and is not yet known to a person of ordinary skill in the art.

### SUMMARY

An embodiment may have a device such as a base station or a user equipment, UE, configured for operating in a wireless communication network; wherein the device is configured for evaluating a set of resource elements, RE, of the wireless communication network for a reception of a signal transmitted from a transmission/reception device, TRD, not serving the device to obtain a measurement result; and wherein the device is configured for providing a report based on the measurement result; or configured for using the measurement result for future operation of the device in the wireless communication network.

Another embodiment may have a wireless communication network having a plurality of transmission/reception devices, TRDs, configured for providing individual communication to devices of the wireless communication network; wherein the wireless communication network is configured for simultaneously transmitting, to a receiving device, a plurality of distinguishable signals.

According to an embodiment, a method for operating a device such as a base station or a user equipment, UE, in a wireless communication network may have the steps of: evaluating a set of resource elements, RE, of the wireless communication network for a reception of a signal transmitted from a transmission/reception device, TRD, not serving the device to obtain a measurement result; and providing a report based on the measurement result; or using the measurement result for future operation of the device in the wireless communication network.

According to an embodiment, a method for operating a wireless communication network having a plurality of transmission/reception devices, TRDs, configured for providing individual communication to devices of the wireless communication network, may have the step of: simultaneously transmitting, to a receiving device, a plurality of distinguishable signals.

Still another embodiment may have a non-transitory digital storage medium having stored thereon a computer program having a program code for performing, when running on a computer, the methods according to the invention as mentioned above.

### BRIEF DESCRIPTION OF THE DRAWINGS

Embodiments of the present invention are described herein making reference to the appended drawings, in which:

FIG. 1a shows a schematic representation of an example of a wireless communication system;

FIG. 1b is a schematic representation of an example of a radio access network RANₙ that may include one or more base stations;

FIG. 2a is a schematic representation of an in-coverage scenario in which UEs directly communicating with each other are connected to a base station;

FIG. 2b is a schematic representation of an out-of-coverage scenario in which UEs directly communicating with each other receive no SL resource allocation configuration or assistance from a base station;

FIG. 3 is a schematic representation of a partial out-of-coverage scenario in which some of the UEs directly communicating with each other receive no SL resource allocation configuration or assistance from a base station;

FIG. 4 is a schematic representation of an in-coverage scenario in which UEs directly communicating with each other are connected to different base stations;

FIG. 5 is a schematic representation of a wireless communication system comprising a transceiver, like a base station or a relay, and a plurality of communication devices, like UEs, according to an embodiment;

FIG. 6 shows a schematic block diagram of a wireless communication network according to an embodiment;

FIG. 7 shows a schematic representation of a resource grid in which resource elements that are each associated to different TRPs or gNBs according to an embodiment;

FIG. 8 shows a schematic representation of an example extended MIMO matrix according to an embodiment;

FIG. 9 shows a schematic flow chart of a method according to an embodiment that may be used for operating a device such as a base station or a user equipment in a wireless communication network;

FIG. 10 shows a schematic flow chart of a method according to an embodiment that may be used for operating a wireless communication network; and

FIG. 11 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details is set forth to provide a more thorough explanation of embodiments of the present invention. However, it will be apparent to one skilled in the art that embodiments of the present invention may be practised without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

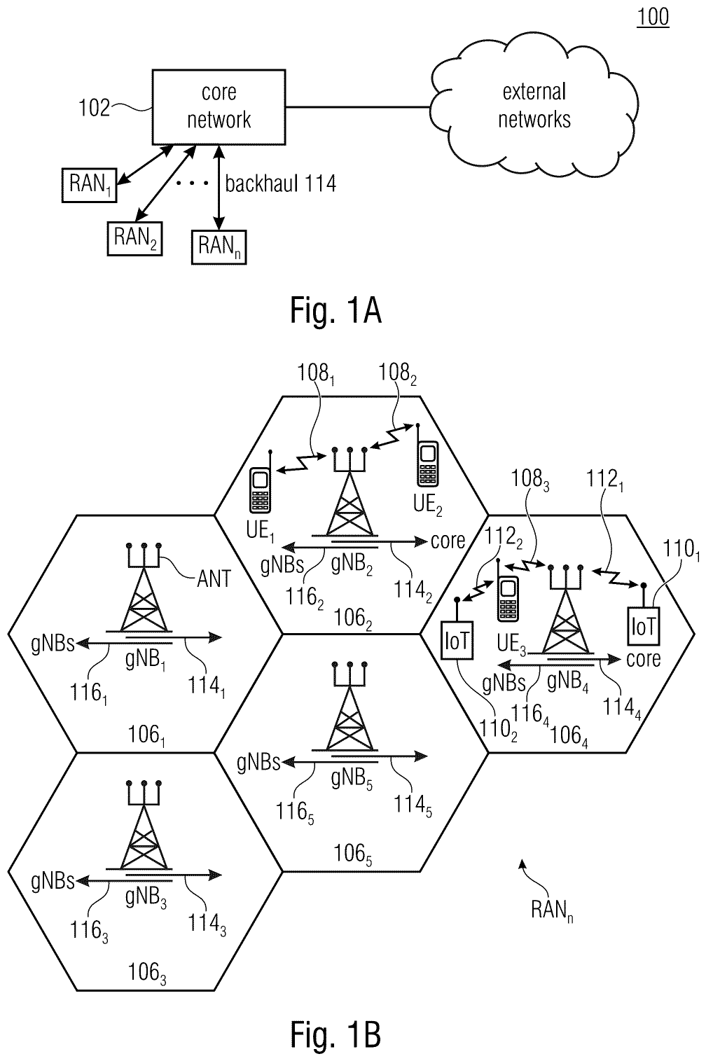

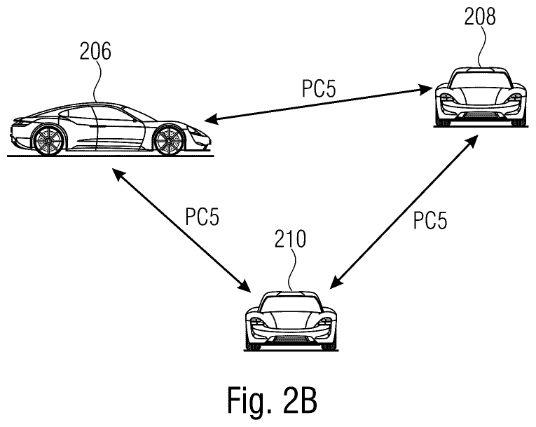

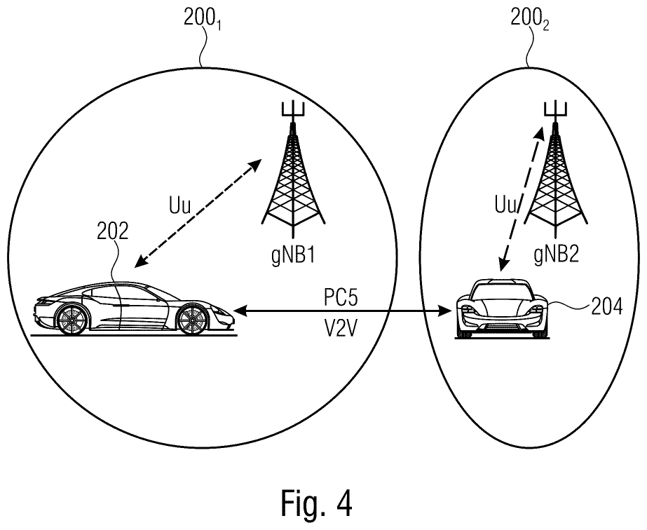

Embodiments of the present invention may be implemented in a wireless communication system or network as depicted in FIGS. 1 to 4 including a transceiver, like a base station, gNB, or relay, and a plurality of communication devices, like user equipments, UEs. FIG. 5 is a schematic representation of a wireless communication system comprising a transceiver 200, like a base station, a transmission reception point, TRP, or a relay, and a plurality of communication devices 202₁ to 202n, like UEs. The UEs might communicate directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the Uu interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Some embodiments overcome the present drawback that a UE cannot be configured about the RSs used beyond the serving cell. Therefore, a known UE is not a priori provided with the appropriate context/information to process CSI-RS from non-serving cells and, implicitly, the beams of the non-serving cells. The known UE is therefore restricted in its ability to determine the source of interference, e.g. from which specific non-serving cell and beam a particular interference contribution is coming from. This inability of the UE limits the interference management within the network. This limitation in terms of active interference management is valid for the known mechanisms available in the networks (e.g. ABS, beam coordination, . . . ) and for future network operational modes like cell free MIMO, CoMP etc.

Some embodiments of the present invention are based on the finding that by extending the capability of a device such as but not limited to a base station or a user equipment to evaluate signals that are at least formally not intended to be evaluated by the device it is possible to obtain additional information that allows to efficiently organize or control the network and/or a future operation of the device itself.

In connection with embodiments described herein transmission/reception devices, TRDs will be used to explain the benefits of the embodiments. Such devices may include a base station, a user equipment and/or a transmission/reception point, TRP, as well as other devices such as IoT. A TRD in connection with embodiments described herein may be understood in connection with several embodiments as a TRP that might be considered to form a part of a network-side of communication. However, the embodiments described herein are not limited to evaluate signals received from a TRP, especially when referring to an evaluation of signals to obtain a measurement result. Such information may be obtained, according to some embodiments, as an addition or as an alternative by evaluating signals transmitted from devices different from a TRP such as the mentioned base station, user equipment or IoT device. Those devices still may have in common that they do not serve the evaluating device, i.e., that the signals are not transmitted to the device as it is done with known reference signals or specific user data.

However, embodiments do not exclude to evaluate such signals being intentionally transmitted to a device such as from a serving TRP in addition to the evaluated signal being received from a non-serving TRD.

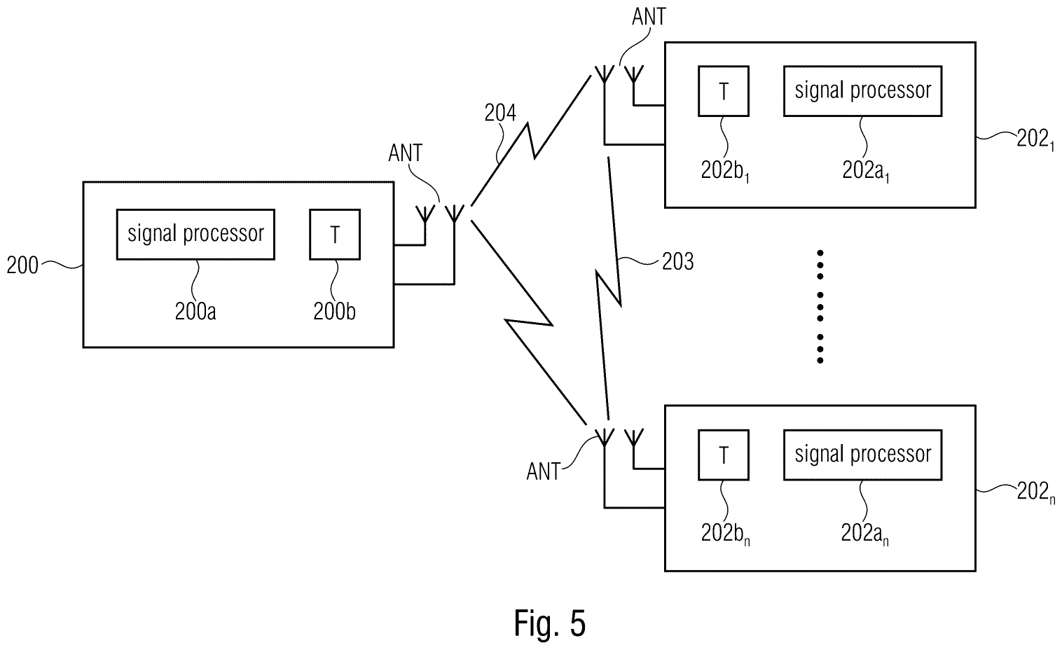

FIG. 6 shows a schematic block diagram of a wireless communication network 600 according to an embodiment. The wireless communication network 600 is shown to comprise two base stations 200₁ and 200₂, wherein any other number of base stations, including zero, may be used for implementing the described invention. FIG. 6 is used to illustrate the concept of cross-link interference, CLI and inter-cell interference, ICI. For example, three UEs 202₁ to 202₃ are operated in the wireless communication network. UEs 202₁ and 202₂ may operate a serving link 302₁, 302₂ respectively with base station 200₁. The base station 200₁ or at least a part such as a TRP thereof may thus serve the UEs 202₁ and/or 202₂. In a direction towards the base station 200₁, the UEs 202₁ and 202₂ may operate uplink and in a direction from the base station 200₁ to the UEs 202₁ and 202₂, there may be operated downlink. Accordingly, UE 202₃ may operate a serving link 3023 with base station 200₂. When considering base stations 200₁ and 200₂ so as to each operating a cell of a same or of different wireless communication networks, signals transmitted from base station 202₂ may cause CLI 304₁ perceived by base station 200₁, i.e., CLI 304₁ is caused for base station 200₁ from another base station.

Accordingly, UE 202₃ may cause CLI 304₂ perceived by UE 202₂ and/or UE 202₁. CLI 304₃ may be caused by UE 202₁ and may be perceived as interference not from a UE served by the same base station by UE 202₃. A different situation arises for UE 202₂ that may perceive CLI 304₄ caused by same or different signals transmitted by UE 202₁ but UE 202₂ is served by a same base station 202₁, a TRP thereof and/or operated in a same cell.

UE 202₃ may cause ICI 306₁ when transmitting a signal, ICI 306₁ perceived, e.g., by base station 200₁. In a same or a different manner, a signal transmitted by base station 200₂ may cause ICI 306₂, e.g., in downlink, for UEs 202₁ and/or 202₂.

A device according to the invention may be configured for receiving, processing and evaluating a signal being sent from a TRD not serving the device. For example, BS 202₁ may decode a signal causing ICI 306₁ and/or a signal causing CLI 304₁. As a further example, the device 202₂ may measure on a signal causing ICI 306₂ or CLI 304₂ and/or 304₄.

As discussed in connection with network 100, a wireless communication network may comprise one or more transmission reception points, TRPs and a base station may comprise one or a plurality of TRPs. According to an embodiment, the base station may comprise a central unit, CU, that is connected to one or more distributed units, DU, and/or radio units RU, that may be operated in a joint or coordinated manner by the CU and that may forward received measurement reports to the CU.

Although FIG. 6 shows only a part of possible interference that may be caused, transmitting a signal from any device within a network may cause interference such as ICI and/or CLI for other devices in a same or a different wireless communication network.

Whereas, for example, UEs 202₁ and/or 202₂ may be coordinated by base station 200₁ so as to process information which resource elements to be monitored and/or decoded with regard to, for example, user data and/or reference signals, such information may not be present, in known systems, for base stations operating different cells and/or devices operated in such cells.

According to an embodiment and with reference to FIG. 6, a device is provided, e.g., base station 200₁, 200₂ or one of the UEs 202₁ to 202₃ that is configured for evaluating a set of resource elements, RE, of the wireless communication network for a reception of a signal transmitted from a TRD not serving the device to obtain a measurement result. The device is configured for providing a report based on the measurement result or is configured for using the measurement results for future operation of the device in the wireless communication network. A combinatory use is also possible, i.e., for providing a report and to benefit from the results of the measurement for the future own operation. That is, a report may provide knowledge for other entities about the signal. However, when the device uses the channel information about the non-serving TRD, for instance for interference rejection combining, IRC, then no report is required to be established. However, additionally providing the report may also allow for knowledge at other devices.

The report may be established for each procedure or under certain circumstances the measurement may relate to an interference such as a cross-link interference, CLI, and/or an inter-cell interference, ICI, perceived by the device. The device may be configured for providing the report if a level of interference is at least an interference threshold level or exceeds a tolerable amount of interference. The device may skip generating or may not generate the report if the level of interference is below the interference threshold level. That is the device may determine whether interference is relevant or not and/or may report only relevant interference to reduce network load. The device interference threshold may be an absolute value or a relative value, e.g., based on signal quality of a used link of the device and/or based on capability of the device to mitigate interference.

The mentioned report may comprise results of the measurements being done and/or information derived from such results. One example is an outcome of a learning-related process such as a monitoring of resource elements over time and/or a combination with other information such as time, location, network load or other information considered as context.

With regard to a use of the measurement for future operation, a device 200 or 202 may select a receive filter for a future reception of a received signal. Such a filter may be selected, for example, in order to properly decode a signal and/or to mitigate interference such as CLI 304 and/or ICI 306.

The future operation of the device may relate to a communication of the device, to a sensing procedure provided by the device, a sensing procedure including the device and/or a positioning procedure including the device. For example, a signal revaluated by the device may comprise a reference signal, RS and/or user data. Example reference signals that may be evaluated by the device may be or may comprise a channel state information, CSI, RS, i.e., a CSI-RS. Such a CSI-RS may be a zero-power RS, ZP-CSI-RS or a non-zero-power RS, NZP-CSI-RS. Alternatively or in addition, the reference signal may comprise or may be a demodulation RS, DMRS, a sounding reference signal, SRS and/or a tracking reference signal, TRS.

The evaluating device may be configured for performing measurements on the set of resource elements.

For example, the device may be a UE and the UE may be unserved or not served by the TRD that is, in the given example, a BS. According to a different embodiment, the device is a base station, BS, that is not served by the TRD that is a UE. However, the BS may receive a measurement report from the UE. According to another embodiment, the device is a BS that receives a measurement report from the TRD that is another BS—thus not serving the device—but which is interfered by the device. According to another embodiment, the device is a UE that provides a measurement report to a UE and/or a BS that is interfered by another device such as a UE. Embodiments allow to observe interference caused by another device, for evaluating an interference source being another device that is served by a base station different from the base station serving the evaluating device or serving other UEs, and/or to enable a reporting of devices, e.g., as a BS for crosslink channel interference and/or caused by uplink channels; or as UEs, e.g., for crosslink channels and/or caused by downlink channels.

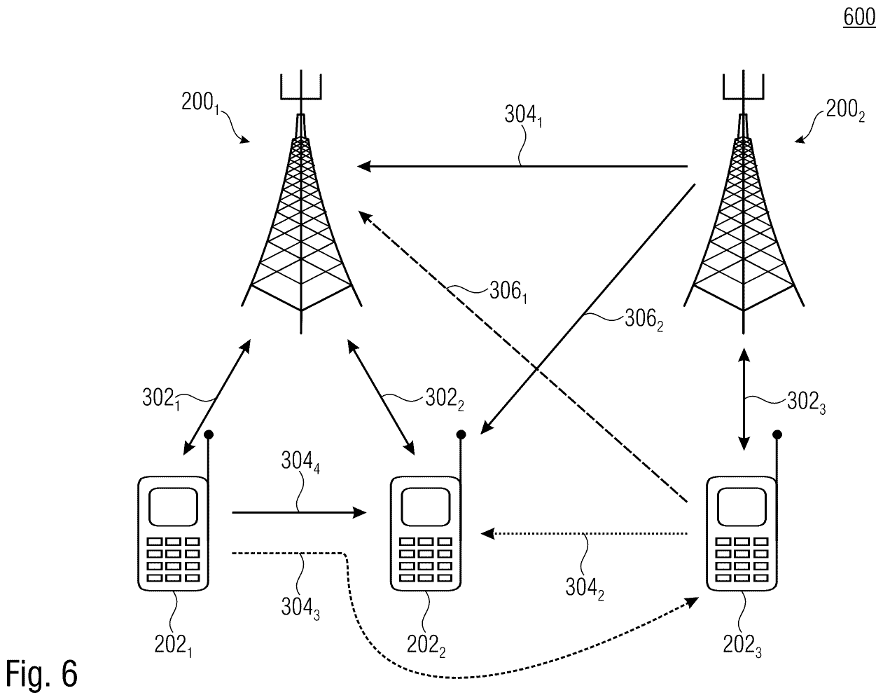

FIG. 7 shows a schematic representation of a resource grid in which resource elements 308, 312, 314 and 316 that are each associated to different TRPs or gNBs are located or arranged. Each of the resource elements 308, 312, 314 and 316 may be individually distributed in the common resource grid, e.g., according to a specific rule or pattern or based on a specific association. Some resource elements such as REs 3081 and 3082 may be located individually in the resource grid whilst other resource elements such as 3083 and 3161 may overlap in the resource grid or, stated differently, the same resource element may be occupied or used by different base stations for transmitting signals. Although showing for the sake of understandability an overlap of only two signals at a same or identical resource element, additional overlaps may also occur. In FIG. 7 an example of a resource grid is shown that illustrates that resource elements are assigned in time (OFDM symbols) and frequency (sub-carries). The grid may be populated with REs containing channel state information reference symbols (CSI-RS) transmitted from the antenna ports associated with, e.g., four different gNBs/TRPs. For convenience, data symbols are not shown and individual antenna ports are not identified.

In FIG. 7 an example of the mapping of CSI-RS signals from different TRPs/gNBs to a resource grid is presented. The figure is simplified in that it does not display the mapping of data symbols through resource elements, these are normally mapped across the entire grid in coordination with the mapping of CSI-RS of a particular gNB/TRP/antenna port/MIMO layer. Knowledge about the distribution of the CSI-RS elements and the source/transmitter ID of each CSI-RS RE observed enables the receiving UE to estimate CSI and interference across a larger set of signal sources than in known systems.

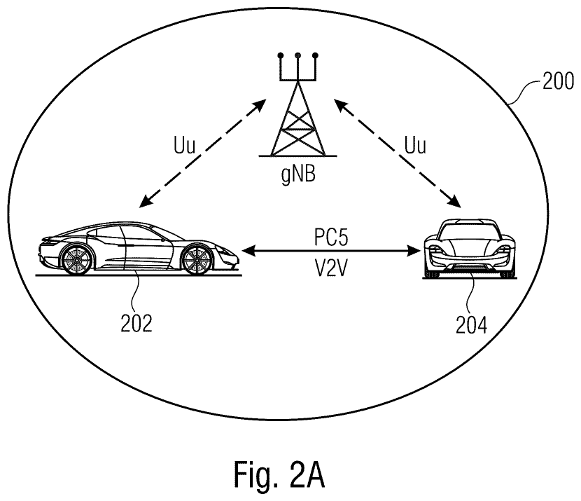

That is, according to an embodiment, the device is implemented to obtain information that indicates an association between a set of signals or reference signals and the group of TRDs. Such information may be broadcasted and/or individually transmitted within the network or may be distributed differently. In accordance with some of the embodiments described herein, there may be assumed that in the example presented in FIG. 2, the RS mapping may be done in either a static or a dynamic fashion. In case of a dynamic fashion, a change of the mapping may be executed continuously or block wise such as triggered, on demand in a configured or pre-configured way and/or in a scheduled manner. The change may be configurable and reportable/declarable, e.g., using messages to be received by the device.

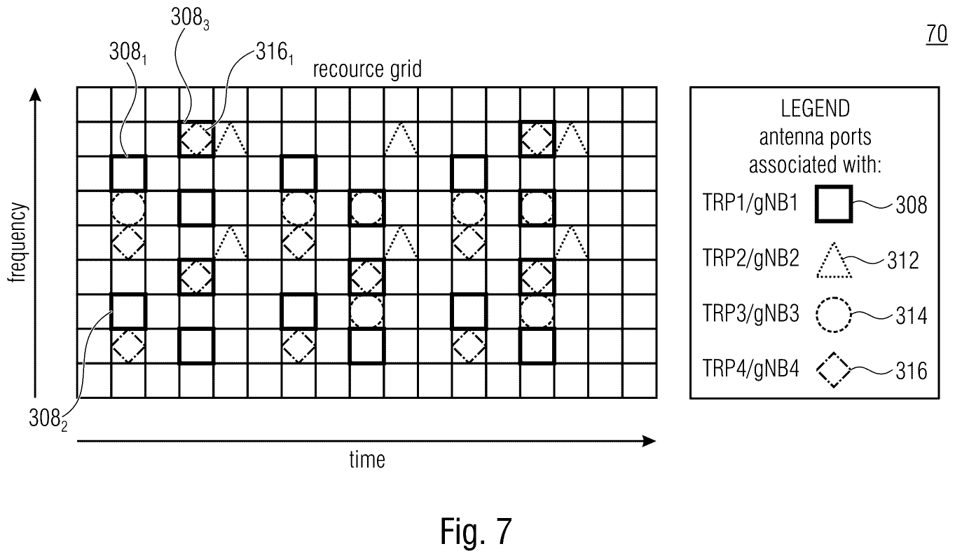

FIG. 8 shows a schematic representation of an example extended MIMO matrix which may be measured at a receiving device and might be shared via a report in part or entirely with the cluster of transmitting entities such as multiple TRPs or other TRDs, e.g., for interference management purposes. When referring to FIG. 8, embodiments of the present invention relate to a method and to devices operating accordingly that involve network entities such as base stations, TRPs and/or UEs that may set up multiple TRPs to coordinate TRP specific CSI-RS such that reliable CSI and interference channel measurements (IM) will be performed. Such a coordination may be part of a network implementation. However, by providing the evaluating device with knowledge about how to distinguish between the same is to be evaluated, the device may also be able to evaluate signals received from a non-serving TRD.

According to embodiments, a transceiver device such as a UE or a base station may be configured to receive CSI-IM resources. The device may measure on particular CSI-IM resource, e.g., once, repeatedly, scheduled, triggered or the like. The device may process the CSI-IM RS/RE considering different information regarding CSI-RS from a serving TRP, which is possibly implemented in known systems. However, deviating from known systems, the device may process the CSI-IM RS/RE considering additional information regarding CSI-RS from non-serving TRDs.

According to embodiments, the transceiver device may further process and/or use the results thereof. For example, the device may prepare a report, e.g., immediately, delayed, logged or the like, wherein the report may contain explicit and/or implicit interference measurements of non-serving TRDs as indicated in FIG. 8, e.g. other BS or parts thereof. For example, it may be reported where the device was receiving from base stations not serving the UE, see also FIG. 7.

Alternatively or in addition, the report may include the applied receiver being pattern and/or spatial layers, e.g., a number and/or a rank, and/or antenna ports through which the receiver determined the interference measurement. Optionally, the report may additionally comprise a corresponding transmit configuration and/or associate reference signals or IDs, e.g., SRS, to be used on a transmitter configuration corresponding to the receiver beam pattern or spatial layers, e.g., number and rank, and/or antenna ports.

Alternatively or in addition, the report may include or refer to the applied transmitted beam ID or any other referenceable means through which the receiver determined the interference measurement. Alternatively or in addition, the report may include the absolute or relative location, position and/or orientation of the measuring device, e.g., the UE.

According to embodiments, the transceiver device may be configured or instructed or requested to transmit the report to the serving TRD/TRP, to a non-serving TRD/TRP and/or to a set of serving TRPs, i.e., a set of collaborating or jointly operating TRDs. Such a joint operation may be understood as jointly transmitting and/or jointly receiving signals which is significantly more when compared to a synchronized operation performed in known networks where in an end-to-end device usually one single device performs reception or transmission.

According to an embodiment, the TRD may be a member of a group of TRDs that each transmit a signal associated with the TRD, e.g., user data or a reference signal, wherein the signals of the devices are configured for selective evaluation. The device may be aware, based on obtaining respective information, about an association between a set of signals and the group of TRDs.

According to an embodiment, the device may comprise a memory and may store reference information with regard to the signals in the memory. The device may evaluate the reception based on the reference information. For example, the device may be told, through the use of signaling, about the association. For example, a signal such as an RS may be distributed across antenna ports and/or TRPs. If different reference signals are transmitted from different locations then the channels associated with each TRP/location may distinguished and/or identified by the evaluating device. If multiple TRPs send the same RS on the same resource element, then the UE may observe a compound or unresolvable superposition of the plurality of channels which is avoided by the solution described herein.

A report in accordance with embodiments that comprises an explicit or implicit result of an interference measurement may allow to distribute knowledge within the network about interference being perceived at one or more devices which allows addressing of such interference at the perceiving device and/or the causing device and/or a centralized coordination to avoid interference or at least control the effects thereof. An interference measurement in connection with embodiments may relate to measuring a total inferference power, a spatial interference information such as a direction-related interference information, a beam such an SSB, a CSI-RS which may be understood as a marking per beam transmitted by a gNB, an SRS marking per beam transmitted by a UE, a polarization-related interference information, an interference power per TRD, an interference power per spatial layer of a TRD, a measurement of interference per channel, e.g., by use of a covariance matrix, per TRD and/or per antenna port, per panel, per sub-panel or the like of an antenna arrangement as well as information about a TRS and/or a DMRS. Alternatively or in addition, the interference measurement may relate to one or more of a receive filter used for measurement of the interference; a transmission configuration indication, TCI, state, e.g., corresponding to a transmission/reception point, TRP, state such as a single-TRP, a multi-TRP or a joint-TRP state; one or more TCI states, wherein the at least one TCI-state relates to a joint or separate TCI states at least one TCI-state for component carriers, CC, or downlink, DL, bandwidth parts; one or more quasi colocation, QCL-types, e.g. quasi co-located or non-colocated; a parameter referring to signals received from different TRPs such as absolute or difference values relating to at least one of an amplitude, a phase and a timing of the signals. The measurement may also relate to a TCI information determined with the device. Such interference measurements ay allow for a precise determination of interference and may also allow for a precise determination of advantageous operation of one or more TRDs, e.g., for a decision whether a maintaining or a switch between a joint TRP state where the device receives multiple signals at a same time and a single TRP state or to a different TRP state is of benefit.

When considering a report structure, the device may establish a full report, i.e., including all information obtainable or derivable by the measurement and/or may establish a partial report or a part of the full report. As mentioned, the report or the part thereof may be provided to at least one of a TRD serving the device, a TRD that transmitted the signal such as the RS or user data, at least one of a set of jointly operating TRDs, a source of interference perceived by the channel operated by the device and at least one member of a set of non-serving TRDs.

When establishing only a part of the report as a partial report to contain a subset of information of the full report, different criteria may be applied to establish such a partial report. The subset of information may be derived from the report or when compared to the report based of at least one of a permission, e.g., of the report receiving node, an authorization, e.g., of the report receiving node, a hierarchy, a size limitation applicable to the report, a prioritization, a relevance, e.g., to only report values that have changed or changed beyond a threshold, a granularity and/or a resolution such as in a temporal, spatial and/or spectrum domain. For example, in knowledge about a capability of the evaluating device and/or permissions/authorizations of the receiving device, the amount of information provided to such a device may be regulated, e.g., to enhance data security and/or avoid unnecessary network load by transmitting unrequired information.

The providing and/or the transmitting/forwarding device may make immediate use of the report but may also store the report for a further processing of the report. For example, the report can be stored for further processing to be done later. Further processing may include one or more of updating the report, compressing the report, comparing new measurements with stored measurement results in the storage, evaluating the stored measurement results or providing a report of a longer period of time, sending parts of the report, providing an updated report to another device as well as keeping a log file of access to the stored data or changes to the stored data such as according to a block chain concept. It is to be noted that a comparison of reports or the part thereof may be done by the providing device or by another device after delivering the report or parts thereof. According to some embodiments, such a device may entail authorization for processing reports at least in some cases.

Further, with regard to the report, the evaluated signal may be one of a set of at least two signals received and evaluated by the device leading to at least a first measurement result when measuring the signal as a first signal and a second measurement result for measuring at least a second signal. The different measurement results may relate to different channels between the device on the one hand and a first or second TRD on the other hand, see, for example, FIG. 6, where a channel may be established or evaluated between each pair of devices.

The device may report also on the additional measurement result and/or may use the additional measurement result for the future operation of the device in the wireless communication network. For example, using the first measurement result and using the second measurement result may be used to mitigate ICI for the different channels to the different TRDs. That is, embodiments are not limited to a case of a downlink from multiple TRDs/TRPs to the device allowing to evaluate DL ICI with channel knowledge. Embodiments also allow devices such as UEs and/or gNBs to measure CLI from other UEs and allow gNBs or other devices to measure the uplink ICI. In such a meaning a TRD can be understood as a device operating like a TRP that may also be implemented by a UE.

As an alternative or in addition to the mitigation of ICI, the device may aim to or assist in avoiding ICI. In accordance with embodiments, the device may be configured for deriving from the first measurement result and the second measurement result a proposal and/or request relating to a joint operation of at least one of beams and antenna ports for a coherent or non-coherent downlink, DL, joint transmission or an uplink, UL, joint reception, e.g., to avoid inter channel interference. A proposal may be considered as a determined solution transmitted to a receiving device or coordinating entity that may coordinate multiple TRDs/TRPs. Such a proposal may serve as an indicator for a solution of a network operation or a contribution to an overall solution. A request may be considered as signal requesting a specific behaviour that may be followed or that may be rejected, not preventing to consider such a request as a proposal.

According to an embodiment, the device is configured for providing an evaluation report or a joint operation mode request based on the proposal, based on the request respectively. The evaluation report may be based on the measurement result obtained at the device and may be based, for example, on a recognition which kind, type or number of beams or signals may be of benefit for the device to be transmitted, thereby entailing receiver devices, and/or to be received, thereby entailing transmitters transmitting signals to the device.

According to an embodiment, the evaluation report, the joint operation mode request respectively may include at least one of: a preferred matrix indicator (PMI), e.g., indicating a preferred configuration of signals or beams to be received, antenna ports to be used at the transmitter and/or receiver or the like; a sorted or unsorted list of: a) preferred beams, antenna ports in selection or combination, b) beams, antenna ports to be avoided in combination, and/or c) combination of preferred beams and beams to be avoided in when selected individually, in sequence or in simultaneous combination; a set of beams, antenna ports and associated PMI, e.g., comprising codebook or port selection entries, phase and/or amplitude information for linear combinations of a selected subset of beams, antenna ports; a mode of transmission or reception to be maintained in single-TRP or multi-TRP mode; a mode of transmission or reception to be changed from single-TRP to multi-TRP mode or from multi-TRP to single-TRP mode; and a mode of transmission or reception to be changed from a first multi-TRP mode to a second multi-TRP mode or from a second multi-TRP to a first multi-TRP-mode.

According to an embodiment, the device may thus indicate or even request to switch between different TRP modes, including but not limited to select the participants of a multi-TRP mode or a single-TRP mode but also to switch from a single-TRP mode to a different single-TRP mode, to switch from a first multi-TRP mode to a different multi-TRP-mode and/or to switch from a single-TRP mode to a multi-TRP mode or vice versa. For example, when operating in a multi-TRP mode and the device recognizes by way of the measurement results that a second beam does not provide for significant advantage in combination with the first beam, it may request to return to a single-TRP mode again or vice versa.

The report provided by the device may comprise at least one of a received beam pattern used for receiving the signal, a directional information of the received beam pattern used for receiving the signal, a polarization information of the received beam pattern used for receiving the signal, a spatial layer used for receiving the signal, a location of resource elements within a resource grid such as the grid shown in FIG. 7, used for evaluating the reception, an antenna port associated with evaluating the reception and a number of antenna ports associated with evaluating the reception. For example, the device may be configured for providing the report to comprise at least one of a transmit configuration of the device, a transmitter reference signal such as an SRS associated with the transmit configuration and/or an identifier, ID, associated with the transmit configuration of the transmitter reference signal.

According to an embodiment, the device may be configured providing the report to comprise information identifying a beam that was used by the TRD to transmit the signal. According to an embodiment, the device may be configured for providing the report to comprise an absolute or a relative location, a position and/or an orientation of the device.

According to embodiments, while CSI-RS REs correspond to up to 32 different antenna ports in known systems, these antenna ports belong to the same gNB/TRP in known systems. In the context of the present invention, these antenna ports can locate different TRPs and/or their total number can exceed 32. The framework of quasi co-location, QCL, refers to channels from the same base station and the spatial correlation between them. In the context of the invention, the QCL information may include spatial correlation to a multiplicity of base stations.

Alternatively or in addition, the framework of TCI may be considered as being used to efficiently transfer QCL information, in the context of the present invention, TCI indications may refer to a multiplicity of base stations or TRDs. At present QCL and TCI information may be provided by the serving base station. In the context of the invention, QCL information and/or TCI indications may be received from a multiplicity of base stations or TRDs. The QCL/TCI information may be mapped, e.g., implicitly and/or explicitly, onto at least one of SS-blocks, DCI-SIB, CORESETs and/or RRC. The QCL/TCI information may be sent/signalled via a single TRD which conveys the message for one or more TRDs in a master-slave/server-client relationship. The QCL/TCI information may be sent/signalled, as an alternative or in addition, via a distribution of multiple TRDs wherein each TRD signals its own messages. Alternatively or in addition, the signalling may relate to a multiplicity of TRDs in which the same messages are signalled by all TRDs. Alternatively or in addition, a network entity/network function might relate to a positioning server, a radio access network intelligent controller, RIC, and/or a third part controller. It is to be noted that when referring to a network entity, such a description may relate, at least in parts, to a network function as described in the standardizations, such as 3GPP. Such a network of functions can be implemented either as a network element on a dedicated hardware, as a software instance running on a dedicated hardware, as a virtualized function instantiated on an appropriate platform such as cloud infrastructure or combinations thereof. A network entity described herein may, thus, be understood as a network function.

Based on the provided QCL/TCI information and/or RSs, the device may, according to embodiments, combine/process the information, e.g., the device may determine the information valid for a defined multiplicity of TRDs such as a group of base stations or a group of TRPs or the like. Alternatively or in addition, the device may calculate, report, store and estimate on the received signals such as reference signals, spatial correlation including phase and amplitude between RS and channels transmitted by multiple ESs/TRPs, TRD respectively. Subject of such calculations, reports and the storage of reports may be a separability of signals from different TRDs by the device, e.g., using spatial layers across multiple TRDs. Alternatively or in addition, the device may report advantageous combinations of signals from different TRDs including amplitude and phase.

At the receiver device such channel estimation may be performed per receiver/antenna port with and/or without spatial beam forming in order to spatially distinguish signals such as RS which are mapped onto the same REs. The receiver may be configured to follow different measurement strategies not limited to include the following:
The device, e.g., receiver receives the RE on different Rx antenna ports without knowledge of from where they were transmitted (unknown DoA)
The device, e.g., receiver, receives the RE on different Rx antenna ports with knowledge of from where they were transmitted (known DoA)
   DoA knowledge can be calculated by receiving device or
   DoA knowledge can be provided by other entities such as interference management function, IMF
   DoA knowledge may be obtained through exploitation of QCL determined CSI-RS and PRS (positioning RS)
A device or receiver capability might be represented by classes, categories, capabilities to be signalled by the device, e.g., to define the information provided by the device.
The device or receiver may be configured by the wireless communication network to use specific spatial filters, e.g., according to a beam correspondence procedure.
   The device, UE, might be configured to use certain uplink beams (marked by SRS) to communicate to a first gNB and/or second gNB through SRI signalled by the gNBs. Further gNBs/TRPs are not excluded.
   In accordance with an embodiment, the device, e.g., UE or BS, may be configured to apply corresponding Rx filters which have a corresponding spatial filter as used for uplink transmission by the UE following the SRI signalled by the at least two gNBs.
      Option1: The device is configured with at least two independent receive filters (corresponding to transmit filters) associated with, e.g., the at least two gNBs/TRDs
      Option2: The device is configured to use joint receive filters (corresponding to transmit filters) associated with the at least two gNBs/TRDs allowing to separate the signals transmitted in the same RE
      Option3: The device is configured to calculate a joint receive filter from the at least two independent receive filters (corresponding to transmit filters) associated with the at least two gNBs/TRDs provided in option1
      Option4: The device is configured to determine the difference between the above given options according to a metric, e.g. SINR, throughput, and provide feedback on the result (difference)

A device in accordance with embodiments may be configured for receiving multiple distinguishable signals from multiple sources, e.g., TRDs, and for providing feedback information such as a type II, CSI feedback, for the plurality of signals. Such a report may be provided commonly for at least two, a selected subset or all of the received signals or may be provided individually for a single signal. For example, two different sources may transmit the distinguishable signals so as to comprise different RS, same RS mapped on different REs, see FIG. 7, and/or same RS used with known and distinguishable modifications such as phase shifts on Zhadoff-Chu sequences, e.g., as used to identify the three sectors of a same gNB. Alternatively or in addition, an overlay of power between the same RS on the same REs with known pattern and/or synchronization may be used.

According to an embodiment, the device may be configured for providing the report to provide the feedback information for the plurality of signals and information identifying a transmitter of a respective signal which may allow to identify, e.g., on a network side, a source of interference.

According to an embodiment, the device may be configured for receiving and processing quasi co-location, QCL, information comprising a spatial correlation to transmitters of the plurality of signals. Alternatively or in addition, the device may be configured for receiving a processing transmission configuration indicator, TCI, relating to transmitters of the plurality of signals. For example, using the QCL and/or TCI, the device may be configured for determining information about used and/or unused resources for transmitting signals, for selected a set of transmitters of the plurality of signals such as base stations or TRDs. Alternatively or in addition, the device may calculate, report, store and/or estimate on the received signals, spatial correlation including phase and amplitude between the signals and channels transmitted by the transmitters of the plurality of signals. Alternatively or in addition, the device may determine a separability of signals from different transmitters of the plurality of signals, e.g., as spatial layers across multiple base stations. Alternatively or in addition, the device may report advantageous combinations of signals from different transmitters of the plurality of signals, e.g., considering amplitude and phase.

A device in accordance with embodiments may be configured for receiving an SRS resource indicator, SRI, for a transmitter of at least one of the signals such as a UE or a mobile termination, MT, part of a relay, and for deriving, from the SRI, a reception filled configuration for using the reception filter configuration for processing a signal from at least one transmitter for the future operation. For example, for an uplink channel sounding, the UE may use SRS and may be configured by the gNB where to map such an SRS in uplink. This configuration may be done by using SRI. The SRI may be sent by the TRP/TRD and may describe REs where specific RS, e.g., SRS, are to be mapped. If another TRP/TRD, especially a non-serving TRD, or another UE from the same or other cell is provided with the SRS and/or SRI, then they can identify the source of interference very accurately for the purpose of reports and/or using the measured channel for interference rejection.

According to an embodiment, the device may be configured with at least two independent receive filters, e.g., corresponding to transmit filters associated with the at least two different transmitters, see option 1 described above. Alternatively or in addition, the device may be configured for calculating a joint receive filter from the at least two independent receive filters and for using the joint receive filter, see option 3 indicated above.

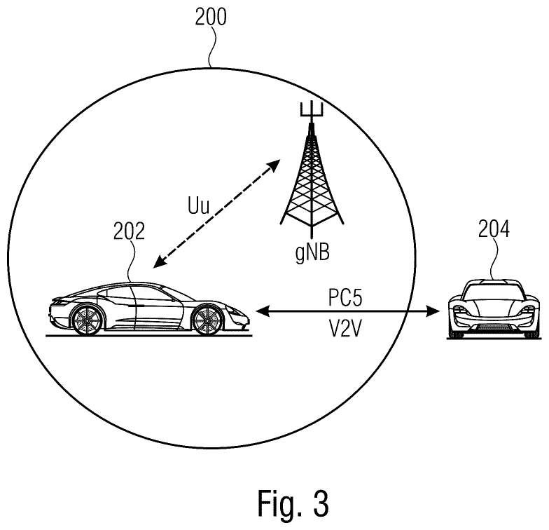

Alternatively or in addition, the device may be configured for using a joint receive filter, e.g., corresponding to transmit filters associated with the at least two transmitters allowing to separate the signals transmitted in the same resource element, see option 2 indicated above. Alternatively or in addition and when referring, for example, to FIG. 4, the device may be configured for determining a measure of a difference between using at least two independent receive filters and a joint receive filter according to a predefined metric, e.g., SINR and/or throughput, and for providing a feedback indicating the measure of the difference.

A report provided by the device may be sent immediately, delayed or as a logged report.

The described functionality of a device may be of particular benefit in a wireless communication network according to an embodiment. However, even without such a specific device, according to the underlying invention, a wireless communication network may comprise a plurality of TRDs, configured for providing individual communication to devices of the wireless communication network. The wireless communication network may be configured for simultaneously, e.g., jointly, transmitting to a receiving device, a plurality of distinguishable signals, e.g., using different TRDs.

The distinguishable signals may be individually marked by a reconfigurable intelligent surface, RIS, e.g., differently marked by different RISs and/or may be transmitted as signals using a plurality of sets of resource elements, wherein at least one of the signals and the set or resource elements are different from one another. Alternatively or in addition, the signals may comprise an individual marker or the like as described above. The signal may comprise reference signals and/or user data.

According to an embodiment, the wireless communication network may be configured for transmitting the plurality of signals with at least one of at least a subset of the plurality of TRDs, the subset having at least two TRDs, a plurality of antenna ports of at least one device in the wireless communication network and a plurality of MIMO layers of at least one device in the wireless communication network.

According to an embodiment, the wireless communication network may be configured for providing, to the receiving device, mapping information indicating a mapping of resource elements of the wireless communication network to reference signals and/or user data.

According to an embodiment, the wireless communication network may be adapted for transmitting the plurality of signals as non-precoded signals or as precoded signals.

According to an embodiment, the wireless communication network may be adapted for transmitting the plurality of signals as precoded signals and to provide precoded information relating to the precoding of the receiving device, to the receiving device respectively.

According to an embodiment, the wireless communication network may be adapted for receiving, from the receiving device, a MIMO feedback responsive to a reception of the plurality of signals with the receiving device. The wireless communication network may be adapted for configuring a precoding of at least one TRD based on the feedback. Such an adaptation may be used, for example, for interference mitigation.

The wireless communication network being subject to an embodiment may be adapted for providing the plurality of signals as part of synchronization signal blocks or a single synchronization signal block or a part of a physical downlink shared channel, PDSCH, data.

According to an embodiment, the wireless communication network may be adapted for providing information identifying a configuration of the signals, e.g., CSI-RS self-describing information, in a synchronization signal block, SSB.

According to an embodiment, the wireless communication network may be adapted for simultaneously or jointly transmitting the plurality of distinguishable signals as a first plurality of distinguishable signals to the device as a first device. The wireless communication network may be adapted for simultaneously transmitting a second plurality of distinguishable signals to a second device. The first device and the second device may be configured for evaluating a set of resource elements, RE, of the wireless communication network for a reception of the first or second plurality of signals to obtain measurement results. The first device and the second device may be configured for providing a report based on the measurement results, e.g., when reporting each or a combined report. For example, the wireless communication network may be configured for storing the reports, e.g., for a machine learning process or the like. A device or the network may learn, e.g., locations/directions having at least a predefined or less than a predefined amount of interference. Alternatively or in addition, the learning may relate to a number and/or contribution ratios of interference sources. Alternatively or in addition, positions and/or locations from fingerprinting when receiving known RSs from a base station with known locations may be learned. Alternatively or in addition, patterns of interference, patterns of interference mitigation/avoidance, location of devices or gNBs and/or results such as activity, mobility or mobility traces of devices may be learned.

According to an embodiment, the reports may be stored in a predefined memory and/or for a predefined amount of time in the wireless communication, in a single or in a distributed device.

According to an embodiment, the wireless communication network is adapted for retrieving saved reports, e.g., for a machine learning process.

According to an embodiment, the wireless communication network may be adapted for retrieving saved reports and for comparing the retrieved reports to determine a reason for a change in the measurement reports. The wireless communication network may be adapted to modify operation of the wireless communication network based on the reason. By having stored former reports and information about further changes in the network, there might be determined a reason for the change, e.g., of interference which may be used to control interference and/or mitigate interference.

According to an embodiment, the wireless communication network may be adapted for retrieving a saved report and for comparing the retrieved report with an actual or newer or older report to determine a reason for a change in the measurement report. The wireless communication network may be adapted to modify an operation of the wireless communication network based on the determined reason.

According to an embodiment, the wireless communication network may be configured for providing quasi-co-location, QCL, information comprising a spatial correlation to transmitters of the plurality of signals and/or a transmission configuration indicator, TCI, relating to transmitters of the plurality of signals.

According to an embodiment, the wireless communication network may be configured for providing the QCL and/or TCI referring to at least one physical channel such as PDCCH, PDSCH, PUSCH, PUCCH or the like, associated with at least one of a single base station, a distribution of multiple base stations wherein each base station signals its own messages, a multitude of base stations in which the same messages are signalled by all base stations and a network function such as a positioning server, a RAN intelligent controller, RIC, or a third party controller.

Embodiments of the present invention relate to a technical solution having some, a combination of or even all of the following aspects:
A new CSI-RS concept according to which CSI-RS are transmitted by multiple TRDs/TRPs/antenna ports/MIMO layers using the same REs, e.g., using the same identical sub-carrier mapping in the OFDM symbol;
The REs for interference measurement are known to the measuring device explicitly through configuration or an information which may come from a database, e.g., interference management function, IMF, and the REs may be coordinated by the network, gNBs, wherein the coordination and/or associated CSI-RS or IM-RS mapping may be provided to the measuring device;
The joint CSI-RS may be precoded or non-precoded;
The measuring device, UE, may be informed if certain CSI-RS are precoded and how they are precoded, or whether they are non-precoded;
The UE may be configured to provide MIMO type-II feedback for precoding of the multiple SSBs/TRPs/TRDs;
The joint CSI-RS can be part of an SSB or PDSCH data;
The report may include the applied receiver being pattern or spatial layers through which the receiver determined the interference measurement; and/or
CSI-RS self-describing information may be contained, e.g., in SSB.

This may allow the SSB to be decoded while ignoring certain RE as DM-RS due to them originating from other sources.

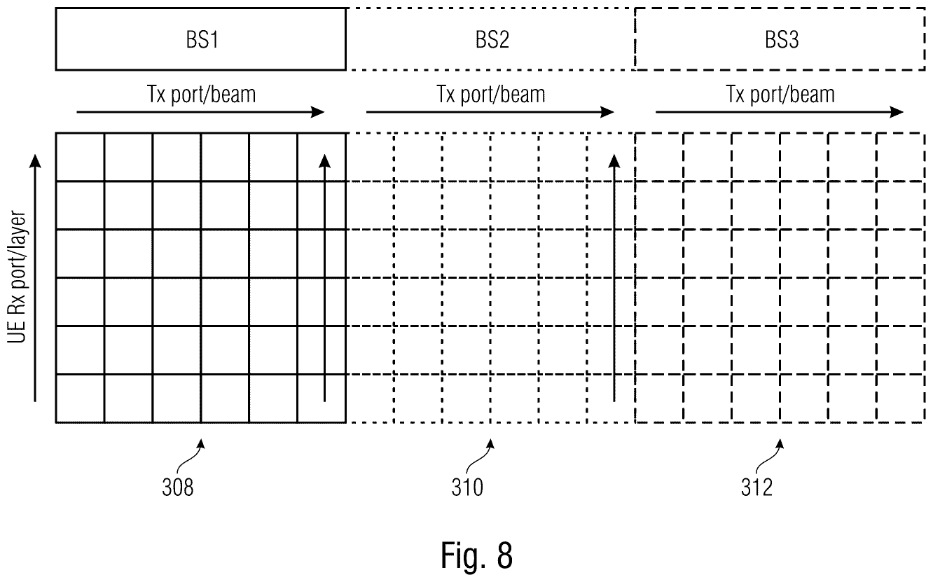

FIG. 9 shows a schematic flow chart of a method 900 according to an embodiment. The method may be used for operating a device such as a base station or a user equipment in a wireless communication network. A step 910 comprises evaluating a set of resource elements, RE, of the wireless communication network for a reception of a signal transmitted from a transmission/reception device, TRD, not serving the device to obtain a measurement result. A step 920 comprises providing a report based on the measurement result and/or using the measurement result for future operation of the device in the wireless communication network.

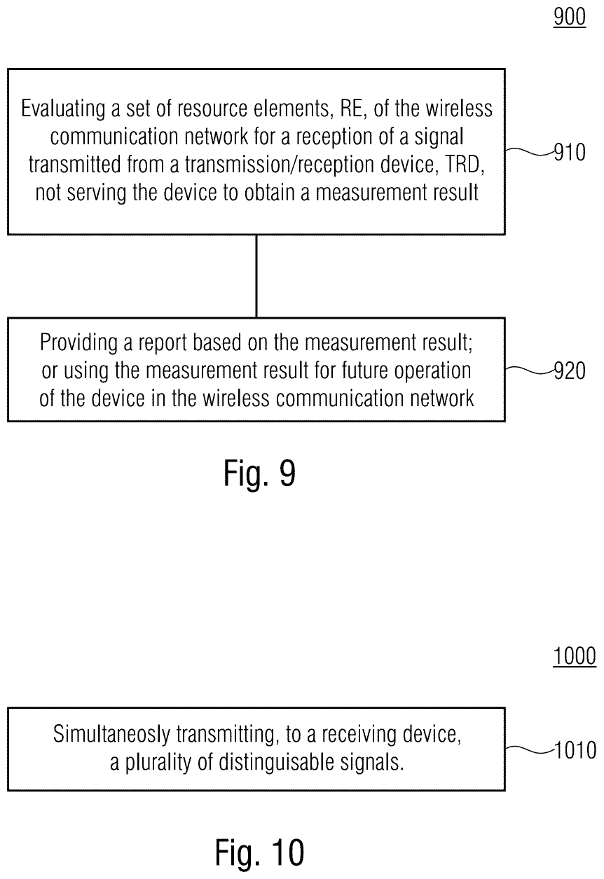

FIG. 10 shows a schematic flow chart of a method 1000 according to an embodiment that may be used for operating a wireless communication network comprising a plurality of transmission/reception devices, TRDs, configured for providing individual communication to devices of the wireless communication network. Method 1000 comprises a step 1010 in which to a receiving device a plurality of distinguishable signals is simultaneously transmitted.

In an embodiment, a computer readable digital storage medium has stored therein a computer program having a program code for performing, when running on a computer, a method described herein.

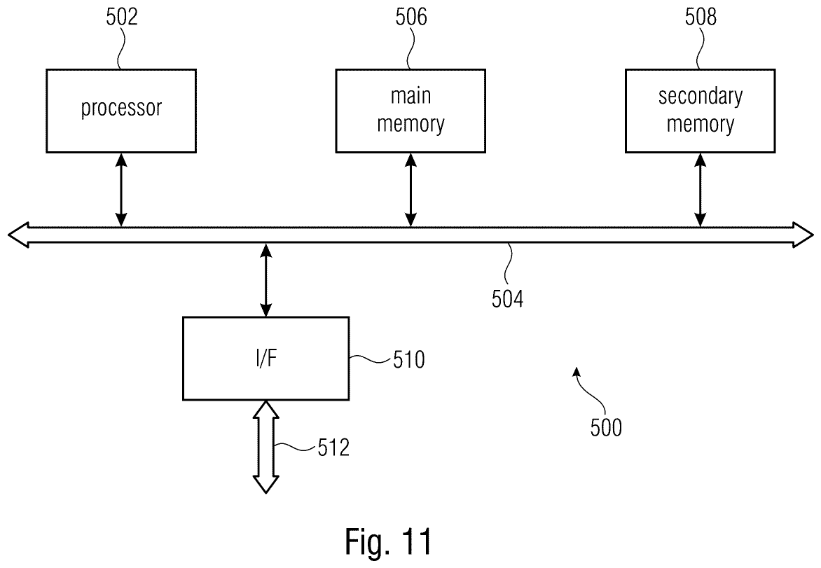

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 11 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fibre optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

Additional embodiments include the following:

A device according to embodiments herein, wherein the device is configured for providing the report to comprise at least one of:
a receive beam pattern used for receiving the signal;
a directional information of the receive beam pattern used for receiving the signal;
a polarization information of the receive beam pattern used for receiving the signal;
a spatial layer used for receiving the signal;
a location of resource elements within a resource grid used for evaluating the reception;
an antenna port associated with evaluating the reception; and
number of antenna ports associated with evaluating the reception.

A device according to embodiments herein, wherein the device is configured for providing the report to comprise at least one of:
a transmit configuration of the device;
a transmitter reference signal such as a sounding reference signal, SRS, associated with the transmit configuration;
an identifier, ID, associated with the transmit configuration or the transmitter reference signal.

A device according to embodiments herein, wherein the device is configured for providing the report to comprise information identifying a beam that was used by the TRD to transmit the signal.

A device according to embodiments herein, wherein the device is configured for providing the report to comprise at least one of:
an absolute or relative location,
a position, and
an orientation of the device.

A device according to embodiments herein, wherein the device is configured for providing at least a part of the report to at least one of:
a TRD serving the device,
the TRD that transmitted the signal, e.g., RS or user data;
at least one of a set of TRDs that jointly serve the device;
a source of interference perceived by the channel; and
at least one member of a set of non-serving TRDs.

The above device, wherein the device is configured for providing the part of the report as a partial report that contains a subset of information of the report, wherein the subset is derived from the report based on at least one of:
a permission, e.g., of the report receiving node;
an authorisation, e.g., of the report receiving node,
a hierarchy,
a size limitation applicable to the report,
a prioritisation,
a relevance, e.g., to only report values that have changed or changed beyond a threshold;
a granularity,
a resolution such as in a temporal, spatial and/or spectral domain.

A device according to embodiments herein, further configured for storing the measurement result and/or the report in a memory for further processing of the report, or wherein the device is configured for receiving multiple distinguishable of signals from multiple sources and for providing feedback information, e.g., a type II CSI feedback, for the plurality of signals.

A device according to embodiments herein, wherein the signals are distinguishable based on at least one of:
different RS comprised by the signals;
a same RS comprised by at least two signals that are mapped on different resource elements, REs,
a same RS comprises by at least two signals comprising a predefined and known and distinguishable modification such as phase shifts on Zhadoff-Chu sequences as used to identify the 3 sectors of a same gN; and
an overlay of power between same RS on the same REs with a known pattern and/or synchronisation.

A device according to embodiments herein, wherein the device is configured for providing the report to provide the feedback information for the plurality of signals and information identifying a transmitter of a respective signal, or wherein the device is configured for receiving and processing quasi co-location, QCL, information comprising a spatial correlation to transmitters of the plurality of signals, or wherein the device is configured for receiving and processing a transmission configuration indicator, TCI, relating to transmitters of the plurality of signals.

A device according to embodiments herein, wherein the device is configured for at least one of:
determining information about used and/or unused resources for transmitting signals, for a selected set of transmitters of the plurality of signals such as BSs or TRDs;
calculating, reporting, storing and/or estimating on the received signals, spatial correlation including phase and amplitude between the signals and channels transmitted by the transmitters of the plurality of signals;
determining a separability of signals from different transmitters of the plurality of signals by the device, e.g., as spatial layers across multiple BSs; and
determining preferred combinations of signals from different transmitters of the plurality of signals, e.g., considering amplitude and phase.

A device according to embodiments herein, wherein the device is configured for receiving a SRS resource indicator, SRI, for a transmitter of the signal such as a UE or a mobile termination, MT, part of a relay, and for deriving, from the SRI, a reception filter configuration and for using the reception filter configuration for processing a signal from the at least one transmitter for the future operation.

A device according to embodiments herein, wherein the device is configured with at least two independent receive filters, e.g., corresponding to transmit filters associated with the at least two different transmitters, or wherein the device is configured for calculating a joint receive filter from the at least two independent receive filters and for using the joint receive filter, or wherein the device is configured for using a joint receive filter, e.g., corresponding to transmit filters associated with the at least two transmitters allowing to separate the signals transmitted in the same resource element, or wherein the device is configured for determining a measure of a difference between using at least two independent receive filters and a joint receive filter according to a predefined metric, e.g. SINR and/or throughput, and for providing a feedback indicating the measure of the difference, or wherein the device is configured for receiving, and for providing the report immediately, delayed or as a logged report.

In other embodiments, a wireless communication network comprising a plurality of transmission/reception devices, TRDs, configured for providing individual communication to devices of the wireless communication network; wherein the wireless communication network is configured for simultaneously transmitting, to a receiving device, a plurality of distinguishable signals.

The wireless communication network, wherein the distinguishable signals are individually marked by a reconfigurable intelligent surface, RIS; and/or are transmitted as signals using a plurality of sets of resource elements; wherein at least one of the signals and the sets of resource elements are different from one another, or wherein the signals comprise reference signals or user data, or wherein the wireless communication network is configured for transmitting the plurality of signals with at least one of:
at least a subset of the plurality of TRDs, the subset having at least two TRDs;
a plurality of antenna ports of at least one device in the wireless communication network; and
a plurality of MIMO layers of at least one device in the wireless communication network.

The wireless communication network, wherein the wireless communication network is configured for providing, to the receiving device, mapping information indicating a mapping of resource elements of the wireless communication network to reference signals and/or user data, or wherein the wireless communication network is adapted for transmitting the plurality of signals as non-precoded signals or precoded signals, or wherein the wireless communication network is adapted for transmitting the plurality of signals as precoded signals and to provide precoding information relating to the precoding of/to the receiving device, or wherein the wireless communication network is adapted for receiving, from the receiving device, a MIMO feedback responsive to a reception of the plurality of signals with the receiving device; wherein the wireless communication network is adapted for configuring a precoding of at least one TRD based on the feedback, or wherein the wireless communication network is adapted for providing the plurality of signals as part of a synchronization signal block, SSB, or as a part of physical downlink shared channel, PDSCH, data, or wherein the wireless communication network is adapted for providing information identifying a configuration of the signals, e.g., CSI-RS self-describing information, in a synchronization signal block, SSB, or wherein the wireless communication network is adapted to/for simultaneously transmitting the plurality of distinguishable signals as a first plurality of distinguishable signals to the device as a first device; and is adapted to for simultaneously transmitting a second plurality of distinguishable signals to a second device; wherein the first device and the second device are configured for evaluating a set of resource elements, RE, of the wireless communication network for a reception of the first or second plurality of signals to obtain measurement results; and wherein the first device and the second device are configured for providing a report based on the measurement results.

The wireless communication network being configured for: storing the reports, e.g., for a machine learning process, or storing the reports in a predefined memory and/or for a predefined amount of time.

The wireless communication network, adapted for: retrieving saved reports for a machine learning process, or retrieving saved reports for and for comparing the retrieved reports to determine a reason for a change in the measurement reports; wherein the wireless communication network is adapted to modify an operation of the wireless communication network based on the reason, or retrieving a saved report for and for comparing the retrieved report with an actual report to determine a reason for a change in the measurement reports; wherein the wireless communication network is adapted to modify an operation of the wireless communication network based on the reason.

The wireless communication network, wherein the wireless communication network is configured for providing quasi co-location, QCL, information comprising a spatial correlation to transmitters of the plurality of signals and/or a transmission configuration indicator, TCI, relating to transmitters of the plurality of signals, or wherein the wireless communication network is configured for providing the QCL and/or TCI referring to at least one physical channel, e.g. PDCCH, PDSCH, PUSCH, PUCCH associated with at least one of:
a single basestation;
a distribution of multiple basestations wherein each basestation signals its own messages;
a multitude of basestations in which the same messages are signalled by all basestations; and
a network function such as a positioning server, a RAN intelligent controller, RIC, or a 3^{rd} party controller.

A method for operating a device such as a base station or a user equipment, UE, in a wireless communication network, the method comprising: evaluating a set of resource elements, RE, of the wireless communication network for a reception of a signal transmitted from a transmission/reception device, TRD, not serving the device to obtain a measurement result; and providing a report based on the measurement result; or using the measurement result for future operation of the device in the wireless communication network.

A method for operating a wireless communication network comprising a plurality of transmission/reception devices, TRDs, configured for providing individual communication to devices of the wireless communication network, the method comprising; simultaneously transmitting, to a receiving device, a plurality of distinguishable signals.

A computer readable digital storage medium having stored thereupon a computer program having a program code for performing, when running on a computer, a method according to claim 59 or 60.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] https://www.sharetechnote.com/html/5G/5G_CSI_RS.html

| | | Further |
|---|---|---|
| Abbreviation | Definition | description |
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| | strength | |
| CP | control plane | |
| CP1 | control plane 1 | |
| CP2 | control plane 2 | |
| CPRI | common public radio interface | |
| CSI | channel state information | |
| CSI-IM | CSI interference measurement | |
| CSI-RS | CSI reference signal | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity / identification | |
| IF | intermediate frequency | |
| IIOT | industrial internet of things | |
| KPI | key-performance indicator | |
| LTE | long-term evolution | |
| MCG | master cell group | |
| MCS | modulation coding scheme | |
| MDT | minimization of drive tests | |
| MIB | message information block | |
| MIMO | multiple-input / multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA user |
| | | plane and |
| | | control plane |
| | | protocol |
| | | terminations |
| | | towards the |
| | | UE, and |
| | | connected via |
| | | the NG |
| | | interface to the |
| | | 5GC |
| NG-RAN | either a gNB or an NG-eNB | |
| NGSO | non-geostationary orbit | |
| NIC | network interface connection | |
| NR | new radio | |
| NR-U | NR unlicensed | NR operating |
| | | in unlicensed |
| | | frequency |
| | | spectrum |
| NTN | non-terrestrial network | |
| NZP-CSI-RS | non-zero-power CSI-RS | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known as |
| | | PCID |
| PDCP | packet data convergence protocol | |
| PDCCH | physical downlink control channel | |
| PDSCH | physical downlink shared channel | |
| PER | packet error rate | |
| PHY | physical | |
| PLMN | public land mobile network | |
| PRACH | physical random access channel | |
| PUCCH | physical uplink control channel | |
| PUSCH | physical uplink shared channel | |
| PSBCH | physical sidelink broadcast channel | |
| PSCCH | physical sidelink control channel | |
| PSSCH | physical sidelink shared channel | |
| PSFCH | physical sidelink feedback channel | |
| QCL | quasi colocation | |
| RA | random access | |
| RACH | random access channel | |
| RAN | radio access network | |
| RAT | radio access technology | |
| RF | radio frequency | |
| RIM | radio access network information | |
| | management | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | srs resource indicator | |
| SS | synchronization signal | |
| SSB | synchronization signal block | |
| SSID | service set identifier | |
| SS-PBCH | sounding signal / physical broadcast | |
| | channel | |
| TAC | tracking area code | |
| TB | transmission block | |
| TCI | transmission configuration indication | |
| TDD | time division duplex | |
| TN | terrestrial network | |
| TRD | transmit/receive device | |
| TRP | transmission reference point | |
| TSG | technical specification group | |
| UAV | unmanned airborne vehicle | |
| UE | user equipment | |
| UL | uplink | |
| UP | user plane | |
| URLLC | ultra-reliable low latency communication | |
| UTRAN | universal trunked radio access network | |
| V2X | vehicle-to-everything | |
| VoIP | voice over internet protocol | |
| vRAN | virtual ran | |
| WI | work item | |
| WLAN | wireless local area network | |
| ZP-CSI-RS | zero-power CSI-RS | |

1. A device such as a base station or a user equipment, UE, configured for operating in a wireless communication network;
wherein the device is configured for evaluating a set of resource elements, RE, of the wireless communication network for a reception of a signal transmitted from a transmission/reception device, TRD, not serving the device to obtain a measurement result; and
wherein the device is configured for providing a report based on the measurement result; or configured for using the measurement result for future operation of the device in the wireless communication network.

2. The device of claim 1, wherein the TRD comprises one of a base station, a user equipment, a transmission/reception point, TRP, and an IoT device.

3. The device of claim 1, wherein the device is configured for using the measurement for future operation by selecting a receive filter for a future reception of a received signal.

4. The device of claim 1, wherein the future operation relates to a communication of the device, to a sensing procedure provided by the device and/or a positioning procedure including the device.

5. The device of claim 1, wherein the signal comprises a reference signal, RS, or user data.

6. The device of claim 5, the wherein the signal comprises at least one reference signal being one of a channel state information RS, CSI-RS; a demodulation RS, DMRS; a sounding reference signal, SRS, and a tracking reference signal, TRS.

7. The device of claim 1, wherein the device is configured for performing measurements on the set of resource elements.

8. The device of claim 7, wherein the measurement relates to an interference such as a cross-link interference, CLI, and/or an inter-cell interference, ICI, perceived by the device, e.g., in a channel thereof.

9. The device of claim 7, wherein the device is configured for providing the report if a level of interference is at least an interference threshold level; and for not generating the report if the level of interference is below the interference threshold level.

10. The device of claim 9, wherein the interference threshold is an absolute value or a relative value, e.g., based on signal quality of a used link of the device.

11. The device of claim 1, wherein the TRD is a member of a group of TRDs that each transmit a signal associated with the TRD, wherein the signals of the devices are configured for selective evaluation.

12. The device of claim 11, wherein the device is to obtain information that indicates association between a set of signals and the group of TRDs.

13. The device of claim 1, comprising a memory and is configured for storing reference information with regard to the signals in the memory; wherein the device is configured for evaluating the reception based on the reference information.

14. The device of claim 1, wherein the device is configured for providing the report to comprise an explicit or implicit result of an interference measurement.

15. The device of claim 14, wherein the interference measurement relates to:
a total interference power;
a spatial interference information, e.g., a direction-related interference information;
a beam, e.g. SSB, CSI-RS (marking per beam transmitted by a gNB), SRS (marking per beam transmitted by a UE)
a tracking reference signal, TRS;
a demodulation RS, DMRS;
a polarization-related interference information;
an interference power per TRD;
an interference power per spatial layer of a TRD;
a measurement of interference per channel e.g. covariance matrix, per TRD, per antenna port, per panel, per sub-panel;
a receive filter used for measurement of the interference;
a transmission configuration indication, TCI, state, e.g., corresponding to a transmission/reception point, TRP, state such as a single-TRP, a multi-TRP or a joint-TRP state;
one or more TCI states, wherein the at least one TCI-state relates to a joint or separate TCI states
at least one TCI-state for component carriers, CC, or downlink, DL, bandwidth parts;
quasi colocation, QCL-types, e.g. quasi co-located or non-colocated;
a parameter referring to signals received from different TRPs such as absolute or difference values relating to at least one of an amplitude, a phase and a timing of the signals; and
a TCI information.

16. The device of claim 1, wherein the signal is a first signal; wherein the TRD is a first TRD, wherein the measurement result is a first measurement result; wherein the device is configured for simultaneously evaluating a reception of a second signal transmitted by a second TRD with regard to a channel between the device and the second TRD to obtain a second measurement result; wherein the device is configured for reporting the second measurement result; or configured for using the second measurement result for the future operation of the device in the wireless communication network.

17. The device of claim 16, wherein the device is configured for evaluating, using the first measurement result and using the second measurement result to mitigate an inter channel interference, ICI, for the channel between the device and the first TRD and/or the channel between the device and the second TRD.

18. The device of claim 16, wherein the device is configured for deriving from the first measurement result and the second measurement result a proposal and/or request relating to a joint operation of at least one of beams and antenna ports for a coherent or non-coherent downlink, DL, joint transmission or an uplink, UL, joint reception, e.g., to avoid inter channel interference.

19. The device of claim 18, wherein the device is configured for providing an evaluation report or a joint operation mode request based on the proposal and/or based on the request.

20. The device of claim 19, wherein the evaluation report or the joint operation mode request includes at least one of:
a preferred matrix indicator (PMI),
a sorted or unsorted list of:
preferred beams, antenna ports in selection or combination
beams, antenna ports to be avoided in combination
combination of preferred beams and beams to be avoided in when selected individually, in sequence or in simultaneous combination
a set of beams, antenna ports and associated PMI, e.g., comprising codebook or port selection entries, phase and/or amplitude information for linear combinations of a selected subset of beams, antenna ports;
a mode of transmission or reception to be maintained in single-TRP or multi-TRP mode;
a mode of transmission or reception to be changed from single-TRP to multi-TRP mode or from multi-TRP to single-TRP mode; and
a mode of transmission or reception to be changed from a first multi-TRP mode to a second multi-TRP mode or from a second multi-TRP to a first multi-TRP-mode.

21. A method for operating a wireless communication network comprising the device of claim 1.
